(19) United States
(12) Patent Application Publication
(10) Pub. No.: US 2010/0289564 A1
(43) Pub. Date: Nov. 18, 2010

(54) ELECTRONIC DEVICE AND A METHOD OF BIASING A MOS TRANSISTOR IN AN INTEGRATED CIRCUIT

(75) Inventor: Zhenhua Wang, Embrach (CH)

Correspondence Address: SEED INTELLECTUAL PROPERTY LAW GROUP PLLC, 701 FIFTH AVENUE, SUITE 5400, SEATTLE, WA, 98104-7092, US

(73) Assignee: ST-ERICSSON SA, Plan-les-Ouates (CH)

(21) Appl. No.: 12/783,453

(22) Filed: May 19, 2010

Related U.S. Application Data
(63) Continuation of application No. 12/650,895, filed on Dec. 31, 2009, now abandoned.
Application No. 12/650,895 is a continuation-in-part of application No. PCT/IB2008/052536, filed on Jun. 25, 2008.

(30) Foreign Application Priority Data
Jul. 3, 2007 (EP) 07111637.0

(51) Int. Cl. G05F 3/02

(52) U.S. Cl. 327/543

(57) ABSTRACT

An electronic device has at least one integrated circuit with at least one MOS transistor. An adaptive analog biasing unit is configured to provide an adaptive biasing current for the at least one MOS transistor biased in the saturation region. The adaptive analog biasing unit (AAB) may be on the same chip together with the integrated circuit and may comprise a process monitor unit configure to extract a device parameter of the integrated circuits and a calculation unit configured to generate a bias current based on the output of the process monitor unit. The bias current generated by the calculation unit may be inversely proportional to the extracted device parameter.

### BACKGROUND

1. Technical Field

The present disclosure relates to an electronic device and a method of biasing a MOS transistor in an integrated circuit.

2. Description of the Related Art

Mobile devices like mobile phones are becoming more and more complex as they have to be able to support a plurality of multimedia applications. As a result, power consumption increases significantly and battery lifetime is shortened, putting more pressure on circuit designers to take measures to reduce the power consumption of not only digital circuits but also of analog circuits.

For digital circuits such as a baseband digital signal processor DSP in mobile devices, various low-power techniques can be used including multi-V_{T}, clock gating, multi-supply voltage, power shut-off, substrate biasing, dynamic voltage scaling and adaptive supply voltage scaling. Among these, the adaptive supply voltage scaling has proven to be an efficient way to reduce the power consumption due to the fact that dynamic power consumption decreases with the square of the supply voltage.

By contrast, a generally applicable technique for reducing the power consumption of analog circuits is not available. In analogue circuits, power consumption is required to maintain signal energy above the fundamental thermal noise to achieve the required signal-to-noise ratio. At a give temperature, the minimum power consumption of analog circuits is set by the required signal-to-noise ratio and the required bandwidth. Hence, decreasing the supply voltage, similarly as with the adaptive supply voltage scaling for digital circuits, will not lead to power reduction in analog circuits.

### BRIEF SUMMARY

An embodiment provides an electronic device or an integrated circuit with an analog circuitry which can be biased with higher precision at a lower power consumption.

In an embodiment, an electronic device is provided which comprises at least one integrated circuit with at least one MOS transistor. The electronic device furthermore comprises an adaptive analog biasing unit for providing an adaptive biasing current for the at least one MOS transistor biased in the saturation region. In an embodiment, the adaptive analog biasing unit is arranged on the same chip together with the integrated circuit and comprises a process monitor unit for extracting a device parameter of the integrated circuit and a calculation unit, for generating a bias current based on the output of the process monitor unit. In an embodiment, the bias current generated by the calculation unit is inversely proportional to the extracted device parameter.

In an embodiment, the device parameter equals to μ₀CₒₓW/L, wherein μ₀ is the mobility of the carriers, C_{OX} is the gate capacitance per unit area, W and L are the width and the length of the MOS transistor, respectively.

In an embodiment, the process monitor unit comprises a threshold voltage extraction unit for extracting the threshold voltage and a device parameter extraction unit for extracting the device parameter. The threshold voltage extraction unit receives a DC input voltage and its output voltage corresponds to the sum of the DC input voltage and the extracted threshold voltage. The device parameter extraction unit comprises a MOS transistor and receives the output voltage of the threshold voltage extraction unit as input, which is applied to the gate of the MOS transistor such that the drain current of the MOS transistor is proportional to the device parameter. The drain current of the MOS transistor constitutes the output of the process monitor unit.

In an embodiment, an integrated circuit comprises at least one MOS transistor and an adaptive analog biasing unit for providing an adaptive biasing current for the at least one MOS transistor biased in the saturation region. In an embodiment, the adaptive analog biasing unit comprises a process monitor unit for extracting a device parameter of the integrated circuit and a calculation unit for generating a bias current based on the output of the process monitor unit. In an embodiment, the bias current generated by the calculation unit is inversely proportional to the extracted device parameter.

In an embodiment, a method comprises biasing at least one MOS transistor in an integrated circuit. The at least one MOS transistor is adaptively biased in the saturation region. A device parameter of the integrated circuit is extracted. A bias current is generated which is inversely proportional to the extracted device parameter.

In an embodiment, an adaptive analog biasing automatically adjusts the bias current of MOS transistors which are operating in the saturation region at a lower power consumption while maintaining the desired transconductance over process and temperature variations. This adaptive analog biasing may be implemented in any CMOS process technology and may find applications in analog circuitry and in RF CMOS front-end circuits. MOS transistors are biased adaptively depending on the actual process parameter of each individual sample as well as depending on the temperature to minimize the power consumption while guaranteeing its performance. This may be achieved by a process monitor extracting process parameters and outputting a current Iₑₓ. The optimum bias current is generated based on the extracted process parameter.

In an embodiment, an electronic device comprises: at least one integrated circuit comprising at least one MOS transistor; and an adaptive analog biasing unit configured to provide an adaptive biasing current for the at least one MOS transistor biased in a saturation region and including: a process monitor configured to extract a device parameter of the at least one integrated circuit; and a calculation unit configured to generate a bias current based on an output of the process monitor unit. In an embodiment, the bias current generated by the calculation unit is inversely proportional to the extracted device parameter. In an embodiment, the device parameter equals μ₀CₒₓW/L, wherein μ₀ is a mobility of carriers, Cox is a gate capacitance per unit area, and W and L are a width and a length of the MOS transistor, respectively. In an embodiment, the process monitor comprises a threshold voltage extraction unit configured to extract a threshold voltage and a device parameter extraction unit configured to extract the device parameter; the threshold voltage extraction unit is configured to receive an DC input voltage and to output a voltage corresponding to a sum of the DC input voltage and the threshold voltage (V_{T}); the device parameter extraction unit comprises a MOS transistor and is configured to receive the output voltage of the threshold voltage extraction unit as an input applied to a gate of the MOS transistor of the device parameter extraction unit such that a drain current of the MOS transistor of the device parameter extraction unit is proportional to the device parameter; and the drain current of the MOS transistor of the device parameter extraction unit constitutes an output of the process monitor. In an embodiment, the integrated circuit and the adaptive analog biasing unit are integrated onto a single chip. In an embodiment, the at least one MOS transistor comprises a plurality of MOS transistors, the device further comprising: a scaling module configured to multiply the generated bias current by a set of values and to output a plurality of bias currents for the plurality of MOS transistors.

In an embodiment, an integrated circuit comprises: at least one MOS transistor, and an adaptive analog biasing unit configured to provide an adaptive biasing current for the at least one MOS transistor biased in the saturation region, and including: a process monitor configured to extract a device parameter of the integrated circuit; and a calculation unit configured to generate a bias current based on the extracted device parameter, wherein the bias current generated by the calculation unit is inversely proportional to the extracted device parameter. In an embodiment, the at least one MOS transistor comprises a plurality of MOS transistors, the integrated circuit further comprising: a scaling module configured to multiply the generated bias current by a set of values and to output a plurality of adaptive bias currents for the plurality of MOS transistors. In an embodiment, the process monitor comprises: a threshold voltage extraction unit configured to extract a threshold voltage, to receive a DC input voltage, and to output a sum of the threshold voltage and the received DC input voltage; and a device parameter extraction unit having a MOS transistor and configured to apply the output voltage of the threshold voltage extraction unit to a gate of the MOS transistor of the device parameter extraction unit such that a drain current of the MOS transistor of the device parameter extraction unit is proportional to the device parameter.

In an embodiment, a method comprises: adaptive biasing at least one MOS transistor in an integrated circuit in a saturation region, the adaptive biasing comprising the steps of: extracting a device parameter of the integrated circuit; and generating a bias current which is inversely proportional to the extracted device parameter. In an embodiment, the method further comprises multiplying the generated bias current by a value to obtain an adaptive biasing current supplied to the at least one MOS transistor. In an embodiment, the at least one MOS transistor comprises a plurality of MOS transistors, the method further comprising: multiplying the generated bias current by a set of values to generate a plurality of adaptive biasing currents; and supplying the plurality of adaptive biasing currents to respective MOS transistors in the plurality of MOS transistors.

In an embodiment, an integrated circuit comprises: a plurality of MOS transistors: means for extracting a device parameter of the integrated circuit; means for generating a bias current that is inversely proportional to the extracted device parameter; and means for providing a plurality of adaptive bias currents to respective MOS transistors of the plurality of MOS transistors. In an embodiment, the means for extracting comprises: a voltage extraction unit; and a parameter extraction unit. In an embodiment, the means for generating a bias current comprises a calculator unit coupled to the parameter extraction unit. In an embodiment, the voltage extraction unit comprises a current mirror.

### BRIEF DESCRIPTION OF THE SEVERAL VIEWS OF THE DRAWINGS

Advantages and embodiments of the present disclosure will now be described in more detail with reference to the figures.

FIG. 1 shows a schematic diagram of a heterodyne UMTS receiver.

FIG. 2 shows an input differential pair and a biasing circuit.

FIG. 3 shows a graph of the dependence on the bias current and the transconductance versus temperature.

FIG. 4 shows a graph of wasted current of an analog circuit with constant biasing.

FIG. 5 shows a block diagram of an embodiment of an analog biasing circuit.

FIG. 6 shows a detailed schematic of an embodiment of an analog biasing circuit suitable for use in the embodiment of FIG. 5.

FIG. 7 shows a schematic of an embodiment of a two-stage operation amplifier.

FIG. 8 shows a graph of the amplitude and phase characteristics of an embodiment.

FIG. 9A shows a schematic of a two stage operational amplifier according to an embodiment.

FIG. 9B shows a schematic of a linearized differential transconductor.

FIG. 10 shows a graph of a simulated power reduction according to an embodiment.

FIG. 11 shows a graph depicting Monte Carlo simulation results according to an embodiment.

### DETAILED DESCRIPTION

In the following description, certain details are set forth in order to provide a thorough understanding of various embodiments of devices, methods and articles. However, one of skill in the art will understand that other embodiments may be practiced without these details. In other instances, well-known structures and methods associated with, for example, operational amplifiers, have not been shown or described in detail in some figures to avoid unnecessarily obscuring descriptions of the embodiments.

Unless the context requires otherwise, throughout the specification and claims which follow, the word “comprise” and variations thereof, such as “comprising,” and “comprises,” are to be construed in an open, inclusive sense, that is, as “including, but not limited to.”

Reference throughout this specification to “one embodiment,” or “an embodiment” means that a particular feature, structure or characteristic described in connection with the embodiment is included in at least one embodiment. Thus, the appearances of the phrases “in one embodiment,” or “in an embodiment” in various places throughout this specification are not necessarily referring to the same embodiment, or to all embodiments. Furthermore, the particular features, structures, or characteristics may be combined in any suitable manner in one or more embodiments to obtain further embodiments.

The headings are provided for convenience only, and do not interpret the scope or meaning of this disclosure or the claimed invention.

The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not necessarily intended to convey any information regarding the actual shape of particular elements, and have been selected solely for ease of recognition in the drawings.

For most applications MOS transistors are typically biased in the saturation region to provide the desired gain and bandwidth. The biasing is usually established by the drain-to-source current Ids through the MOS transistor by means of a biasing circuitry.

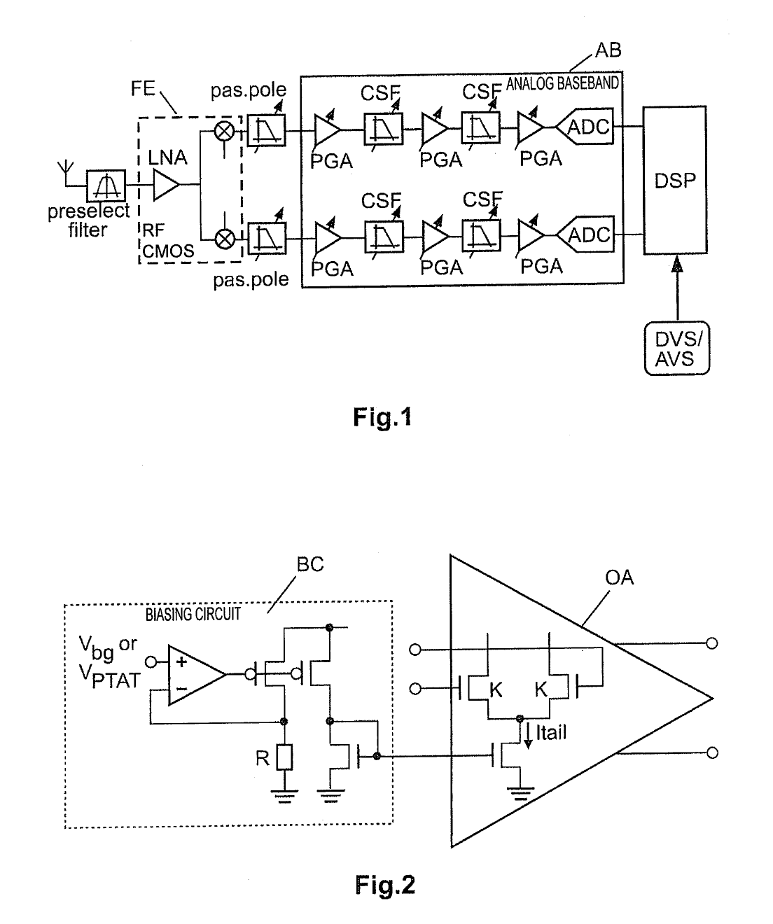

FIG. 1 shows a schematic diagram of a heterodyne UMTS receiver. The receiver comprises a RF CMOS front-end circuit FE and an analog baseband circuit AB. The input signal is received by the antenna and conversion down to baseband is applied. The analog baseband comprises two identical I- and Q-channels. The wanted channels are amplified and selected in analog domain and further processed by the digital signal processor DSP. Each of the I- and Q-channels comprises one or more programmable gain amplifiers PGA, channel selection filters CSF and an analog/digital converter ADC. As an example, the implementation of the programmable gain amplifiers PGA and the channel selection filters as depicted in FIG. 1 requires approximately 14 operational amplifiers for the analog baseband unit. Further operational amplifiers and/or transconductors are typically employed in the analog/digital converter ADC.

FIG. 2 shows a basic circuit diagram of an operational amplifier. The operational amplifier OA is biased by a biasing circuit BC. The transconductance of a MOS transistor biased in saturation region is given by

gm=\sqrt{2I_{ds}K} (1)

wherein I_{ds} is the drain-to-source current and wherein K=μ₀C_{OX}W/L is the transconductance of the MOS transistor, wherein μ₀ is the mobility of the carriers, C_{OX} is the gate capacitance per unit area, W and L are the width and the length of the MOS transistor, respectively. The value of the parameter K depends on the process and temperature. The temperature dependency of the carrier mobility is μ₀∝1/T^{γ}, wherein for most processes γ=1.5 . . . 2.0.

The biasing circuit BC according to FIG. 2 outputs a biasing current for the MOS transistors. The bias current can either be a constant DC current or a current which is proportional to the absolute temperature (PTAT), to establish a desired operating point for the MOS transistors. A constant bias current is usually generated from a reference voltage source, e.g., a bandgap voltage related to an on-chip or external resistor. On the other hand, the PTAT current is generated based on the exponential current-voltage characteristics of MOS transistors in weak inversion.

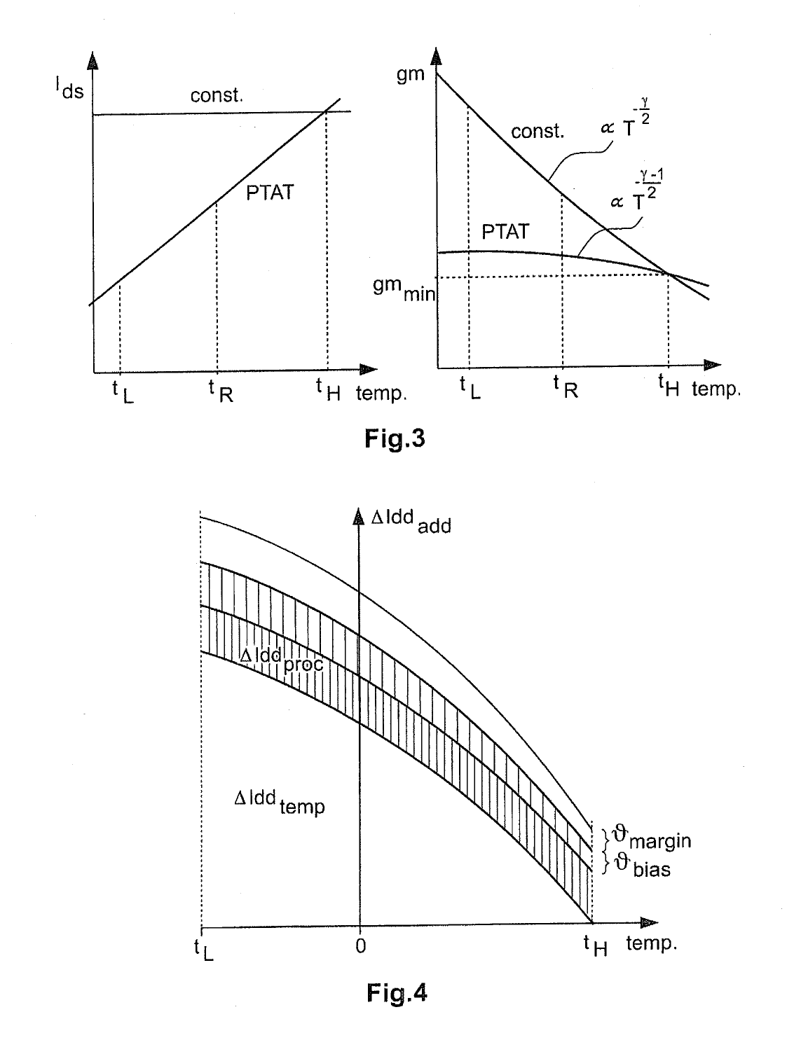

FIG. 3 shows a graph of the dependency of the bias current and the transconductance versus temperature. On the left hand side, the bias current versus temperature is depicted. On the right hand side, the transconductance of a MOS transistor versus temperature is depicted. As temperature increases, the transconductance gm with a constant drain current I_{ds} decreases more rapidly than that with a PTAT current because the PTAT current increases with temperature and can therefore compensate for the decrease in the parameter K. Accordingly, the transconductance of a MOS transistor with a PTAT bias current shows a less steep slope than a transconductance with a constant bias current.

As MOS transistors are subject to both process and temperature variations, analog circuits typically have to fulfill worst case conditions, e.g., a minimum transconductance gmₘᵢₙ. The respective bias current has to be designed such that gm≧gmₘᵢₙ is achieved over entire temperature range t_{L}-t_{H}. This is depicted in the right hand side diagram of FIG. 3, where the transconductance obtained with a constant bias current and the transconductance obtained with a PTAT current meet at t=t_{H} where gm=gmₘᵢₙ.

It should be noted that constant bias current is less power efficient than a PTAT bias current.

The total current consumption of an analog circuit can be expressed as:

Iddₜₒₜₐₗ=(1+θ_{bias}+θ_{margin})(Iddₘᵢₙ+ΔIddₜₑₘₚ+ΔIdd_{proc}) (3)

wherein Iddₘᵢₙ corresponds to the absolute minimum current, ΔIddₜₑₘₚ corresponds to the amount of current which is additionally needed to maintain the required transconductance over the entire temperature range, ΔIdd_{proc} corresponds to the current additionally required to maintain the required transconductance over process variations. The bias current is also affected by temperature and process variations which need to be taken into account. To deal with these variations, the bias current is typically increased by a factor θ_{bias}. Moreover, a safety margin θ_{margin} needs to be added to increase the robustness.

FIG. 4 shows a graph of wasted current in a typical analog circuit for a constant biasing. At temperature t=t_{H}, ΔIddₜₑₘₚ=0. On the other hand, at temperature t=t_{L}, both the transconductance and the wasted current reach a respective maximum. As most analog circuits are designed using constant biasing, a lot of power is wasted especially at lower temperatures.

For analog circuits, the relationship between the total current consumption and the biasing current can be expressed:

Idd_{bias}=β·I_{bias} (4)

wherein β>1. In other words, the total power consumption is proportional to the biasing current, and minimizing bias current can minimize the total current.

U.S. Pat. No. 5,777,518 is related to a method of biasing a MOSFET amplifier in order to obtain a constant transconductance. A first transistor M1 is operated in a triode region to provide a gate-source voltage for a second transistor biased in the saturation region. As a result, the accuracy of the biasing suffers.

The embodiments of the present disclosure provide an adaptive analog biasing for MOS transistors, e.g., in analog circuits, such as analog baseband circuits or in RF CMOS front-end circuits. The biasing of the MOS transistors is controlled by the drain-source current of the respective MOS transistor. If the drain current of a MOS transistor operating a saturation is set that

I_{ds}∝1/K (5)

the transconductance gm of the MOS transistor will be independent of the temperature variations and process deviations. This can be achieved by measuring the process parameter K on chip and by generating a bias current inversely proportional to the measured process parameter K, wherein this bias current is used to bias the MOS transistors.

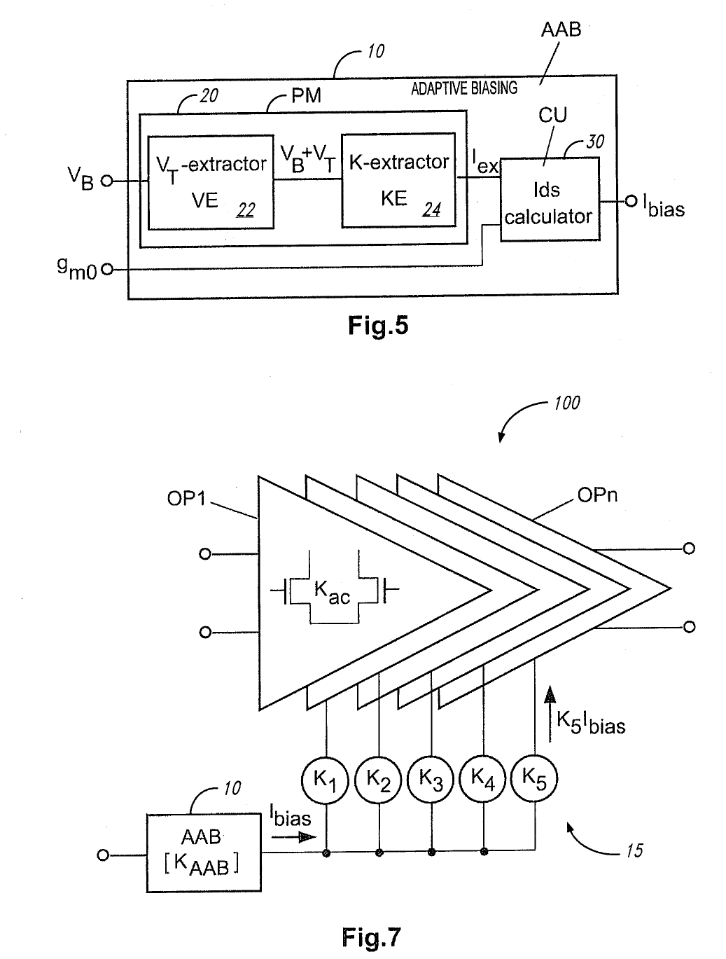

FIG. 5 shows a block diagram of an adaptive analog biasing circuit 10 according to an embodiment. The adaptive analog biasing circuit AAB 10 comprises a process monitor unit PM 20 and a calculator unit CU 30. The calculator unit 30 is configured to calculate the drain current of a MOS transistor. The process monitor unit PM 20 comprises a Vₜ extractor unit VE 22 and a K extractor unit KE 24. The process monitor unit PM 20 is configured to output a current Iₑₓ to the calculator unit CU 30. The calculator unit CU 30 generates the bias current such that the desired transconductance is obtained and is maintained for desired parts and at desired temperatures. The output of the analog biasing circuit AAB is

$${I}_{bias} = \frac{{gm}_{0}^{2}}{{I}_{ex}} \qquad ( 6 )$$

wherein gm₀ is the desired transconductance and wherein Iₑₓ is proportional to K. By substituting the equation (6) into equation (1), a transconductance gm is yielded, which is kept constant.

The process monitor unit PM 20 and the calculator unit CU 30 may be implemented on chip. For more details on the implementations of extractor circuits that may be employed, please refer to “Z. Wang: “Automatic V_{T}-extraction based on an n×n² MOS transistor array and their application”, IEEE J. Solid-State Circuits, vol. 27, no. 9, pp. 1277-1285, 1992” and “Z. Wang: “Direct, fast and accurate measurement of V_{T} and K of an MOS transistor using a V_{T}-sift circuit”, IEEE Trans. Instrum. Meas., vol. 40, no. 6, pp. 951-955, 1991”, which are incorporated herein by reference.

In an embodiment, the two extractor circuits VE 22 and KE 24 are configured to output the extracted V_{T} and K in voltage and current, respectively without any computation and computation delay.

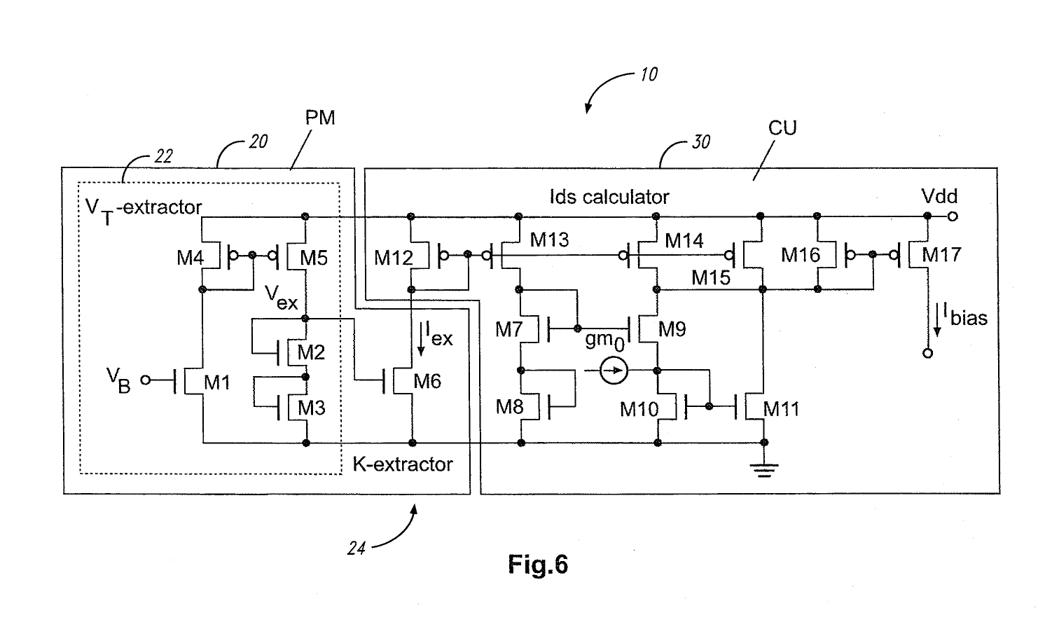

FIG. 6 shows a detailed schematic of an embodiment of an adaptive analog biasing circuit 10, suitable for use, for example, in the embodiment of FIG. 5. Similar reference numbers are used in FIGS. 5 and 6 for similar components. Transistors M1-M3 and M6 operate in saturation region with the size relationship (W/L)₂=(W/L)₃=4(W/L)₁=4(W/L)₆. The transistors M4 and M5 constitute a current mirror with unity gain. With these sizes and for an input DC voltage V_{B}, the output of the V_{T}-extractor VE 22 corresponds to Vₑₓ=V_{B}=V_{T}.

If this voltage is applied to the gate of transistor M6, its drain current is:

$${I}_{ex} = \frac{{K}_{AAB} {V}_{B}^{2}}{2} \qquad ( 7 )$$

wherein the drain current is proportional to parameter K_{AAB}.

The calculator unit CU 30 is configured to perform a division operation according to eq. (6). The calculator unit CU 30 may also be implemented in some embodiments using a current squarer. As illustrated, the transistors M7-M11 have identical sizes and also work in the saturation region. A multi-output current mirror (transistors M12-M15) is used to set the drain current of each transistor equal to the output of the process monitor PM, namely the current Iₑₓ. The common nodes of M9 and M10 are supplied with an input DC current, which corresponds to the desired transconductance gm₀. A second current mirror (transistor M16 and M17) outputs the bias current for an analog circuit as follows:

$$\begin{matrix}{I}_{bias} = ℘ \frac{{gm}_{0}^{2}}{{K}_{AAB}} \\ with & ( 8 ) \\ ℘ = \frac{1}{4 {V}_{B}^{2}} & ( 9 )\end{matrix}$$

If the transconductance of a MOS transistor in an operational amplifier corresponds to K_{ac} and if its drain current corresponds to K times I_{bias}, the transconductance is:

$${gm}_{ac} = \sqrt{κ \frac{{K}_{ac}}{{K}_{AAB}}} {gm}_{0} \qquad ( 10 )$$

In other words, any desired transconductance can be obtained by selecting K_{ac} or κ or both.

FIG. 7 shows an example of a system 100 where several operational amplifiers are used according to an embodiment. Here, operational amplifiers OP1-OPn are coupled to the adaptive analog biasing circuit AAB 10, which is configured to output a biasing current Ids according to equation (8). A scaling module 15 is configured to multiply the bias current by selected values so as to generate a plurality of bias currents. By multiplying the bias current with proper values κ₁-κ₅, the bias current for each operational amplifier can be set individually. In particular, the biasing current for each output stage can be scaled by a proper aspect ratio of the relevant current mirror.

If the voltage V_{B}=1/√2=0.707 V, equation (10) can be simplified to

$${I}_{bias} = \frac{{gm}_{0}^{2}}{{K}_{AAB}} \qquad ( 11 )$$

If κK_{ac}=K_{AAB}, the equation (10) can be reduced to:

gm_{ac}=gm₀ (12)

Accordingly, a MOS transistor of the same size as transistors M1 or M6 will have the transconductance equal to the value of the input current gm₀.

In addition to the reducing power consumption, the robustness of the analog circuits may be improved. This will be described later in more detail.

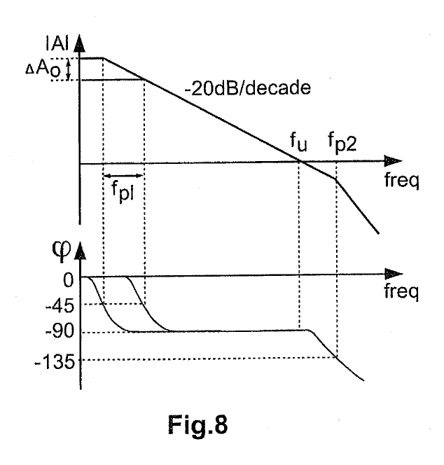

FIG. 8 shows a graph of amplitude and phase characteristics according to an embodiment. Here, a second-order system is depicted. The system will remain stable if the phase margin remains >60° and the second pole is located at a frequency >2.2 fᵤ.

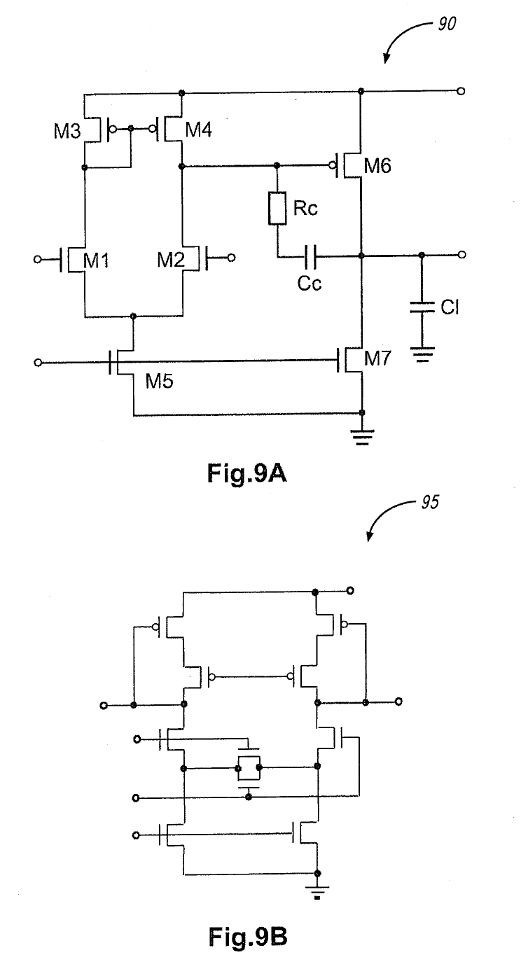

FIG. 9A shows a two-stage CMOS operational amplifier 90. The operational amplifier comprises transistors M1-M7, two capacitors Cc and Cl as well as a resistor Rc. The DC gain of this operational amplifier is

Ao=gm2·gm6/(gd2+gd4)(gd6+gd7) (13)

The unity gain frequency thereof is

fᵤ=gm1/(2πCc) (14)

wherein gm1 corresponds to the transconductance of the input differential pair and wherein Cc corresponds to the Miller compensation capacitance. The second pole is located at:

fₚ₂=gm6/2πC_{L} (15)

When an analog biasing circuit AAB, for example, an embodiment according to FIG. 5 or 6, is used, the transconductance gm1 and gm6 can be maintained constant and unchanged irrespective of process variations and temperature variations. In other words, the frequencies fᵤ and fₚ₂ are kept unchanged if the capacitances Cc and C_{L} are constant.

FIG. 9B shows a circuit schematic of a linearized differential transconductor 95. Linearized differential transconductors are widely used in continuous time Σ/Δ ADC and continuous-time gm-C filters.

Table 1 shows a comparison of constant biasing, PTAT biasing and adaptive analog biasing according to an embodiment.

TABLE 1

| | | constant | PTAT | AAB |
|---|---|---|---|---|
| biasing scheme | | IDS = const. | IDS ∝ KT/q | IDS ∝ 1/K |
| General | gm = √2 · Ids · K | ∝ √K | ∝ √KT | const. |
| | go ≈ λ · Ids | const. | ∝ T | ∝ 1/K |
| 2-stage | fᵤ = gm1/2πCC) | ∝ √K | ∝ √KT | const. |
| op-amp | fₚ₂ = gm6/(2πC_{L}) | ∝ √K | ∝ √KT | const. |
| (FIG. 9A) | | | | |
| linearized | gm = √Ids · K/2 | ∝ √K | ∝ √KT | const. |
| trans- | | | | |
| conductor | | | | |
| (FIG. 9B) | | | | |

In particular, the frequencies fᵤ and fₚ₂ of the operational amplifier according to FIG. 9A and gm of the linearized differential transconductor according to FIG. 9B are compared to those values for constant biasing, for PTAT biasing and for the biasing according to an embodiment such as those shown in FIGS. 5 and 6. In table 1, the values of the transconductance gm and go are compared. Accordingly, it can be seen that by using the adaptive analog biasing circuit AAB, the robustness of the overall system is increased.

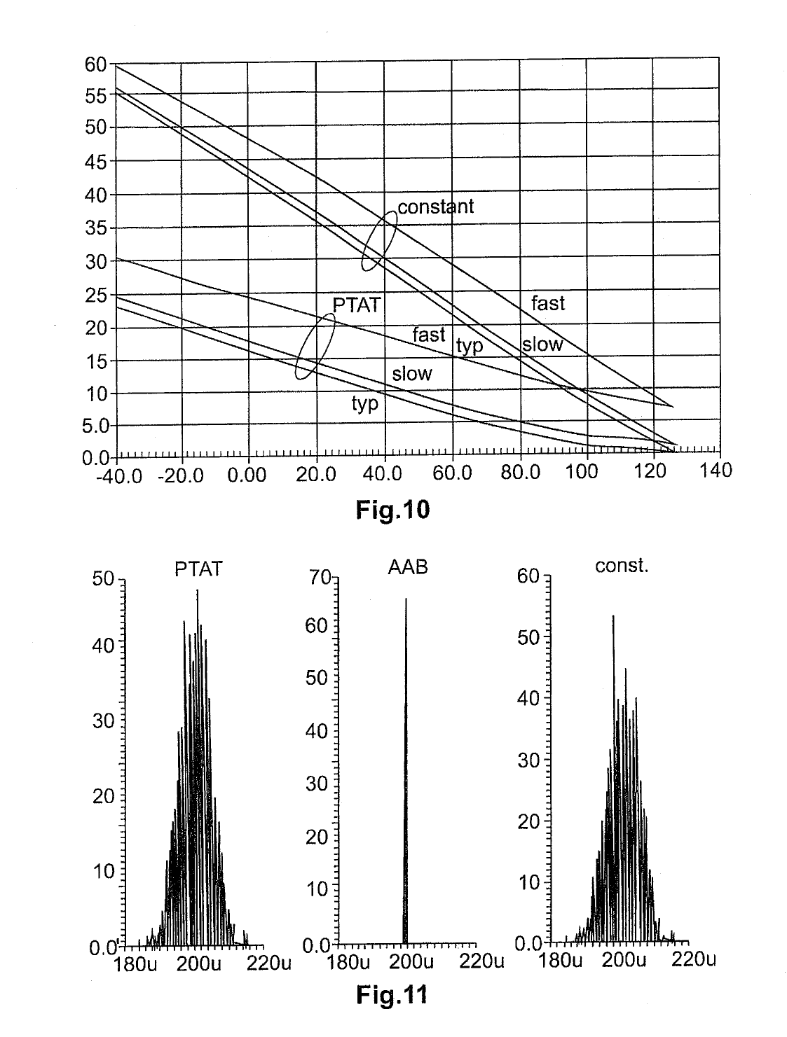

FIG. 10 shows a graph of the expected power reduction with adaptive analog biasing according to an embodiment. At a temperature t=125° C., all three bias currents are equal resulting in an equal transconductance gm. In FIG. 10, with adaptive analog biasing, the power reduction of a system with respect to conventional constant biasing and a PTAT biasing for slow, normal and fast processes are shown. It is seen that a power reduction of up to 31% to 60% can be achieved.

FIG. 11 shows a graph of Monte Carlo simulation results of transconductance distribution due to process variations for constant biasing, PTAT biasing and an adaptive analog biasing according to an embodiment. In the middle of the graph, the Monte Carlo simulation based on the biasing according to an embodiment is depicted. On the left side, the result of a PTAT biasing is depicted and on the right, the result of a constant biasing is depicted. The total number of runs is 1000. All three bias currents were set equal to correspond to gm=200 μA/V. The simulation results show a Gaussian distribution with a mean value of 200 μA/V with all three biasing schemes. For the PTAT biasing the standard deviation is 4,68413μ, for the constant biasing the standard deviation is 4,64179μ and for the adaptive analog biasing according to an embodiment, the standard deviation is reduced to 191,677n by a factor of 24.

The adaptive analog biasing can be used for biasing MOS transistors in the RF CMOS front-end circuit FE and the analog baseband circuit AB as shown in FIG. 1.

The application of the above described embodiments of adaptive analog biasing is virtually endless, including (but is not limited to) analog baseband circuits, switched-capacitor (SC) filters, switched-capacitor Σ/Δ analog/digital converters ADC, continuous-time RC filters, continuous-time gm-C filter, continuous-time Σ/Δ ADC, automatic gain control AGC, amplifiers or poly-phase filters and last but not least in RF CMOS front-end circuits, LNA, mixers etc.

It should be noted that the above-mentioned embodiments illustrate rather than limit the disclosure and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. In the device claim enumerating several means, several of these means can be embodied by one and the same item of hardware. The mere fact that certain measures are recited in mutually different dependent claims does not indicate that a combination of these measures cannot be used to advantage.

The various embodiments described above can be combined to provide further embodiments. All of the U.S. patents, U.S. patent application publications, U.S. patent application, foreign patents, foreign patent application and non-patent publications referred to in this specification and/or listed in the Application Data Sheet are incorporated herein by reference, in their entirety. Aspects of the embodiments can be modified, if necessary to employ concepts of the various patents, application and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An electronic device, comprising:
at least one integrated circuit comprising at least one MOS transistor; and
an adaptive analog biasing unit configured to provide an adaptive biasing current for the at least one MOS transistor biased in a saturation region and including:
a process monitor configured to extract a device parameter of the at least one integrated circuit; and
a calculation unit configured to generate a bias current based on an output of the process monitor unit.

2. The electronic device of claim 1 wherein the bias current generated by the calculation unit is inversely proportional to the extracted device parameter.

3. The electronic device according to claim 1 wherein
the device parameter equals μ₀CₒₓW/L,
wherein μ₀ is a mobility of carriers, Cox is a gate capacitance per unit area, and W and L are a width and a length of the MOS transistor, respectively.

4. The electronic device according to claim 1, wherein:
the process monitor comprises a threshold voltage extraction unit configured to extract a threshold voltage and a device parameter extraction unit configured to extract the device parameter;
the threshold voltage extraction unit is configured to receive an DC input voltage and to output a voltage corresponding to a sum of the DC input voltage and the threshold voltage (V_{T});
the device parameter extraction unit comprises a MOS transistor and is configured to receive the output voltage of the threshold voltage extraction unit as an input applied to a gate of the MOS transistor of the device parameter extraction unit such that a drain current of the MOS transistor of the device parameter extraction unit is proportional to the device parameter; and
the drain current of the MOS transistor of the device parameter extraction unit constitutes an output of the process monitor.

5. The electronic device of claim 1 wherein the integrated circuit and the adaptive analog biasing unit are integrated onto a single chip.

6. The electronic device of claim 1 wherein the at least one MOS transistor comprises a plurality of MOS transistors, the device further comprising:
a scaling module configured to multiply the generated bias current by a set of values and to output a plurality of bias currents for the plurality of MOS transistors.

7. An integrated circuit, comprising:
at least one MOS transistor, and
an adaptive analog biasing unit configured to provide an adaptive biasing current for the at least one MOS transistor biased in the saturation region, and including:
a process monitor configured to extract a device parameter of the integrated circuit; and
a calculation unit configured to generate a bias current based on the extracted device parameter, wherein the bias current generated by the calculation unit is inversely proportional to the extracted device parameter.

8. The integrated circuit of claim 7 wherein the at least one MOS transistor comprises a plurality of MOS transistors, the integrated circuit further comprising:
a scaling module configured to multiply the generated bias current by a set of values and to output a plurality of adaptive bias currents for the plurality of MOS transistors.

9. The integrated circuit of claim 7 wherein the process monitor comprises:
a threshold voltage extraction unit configured to extract a threshold voltage, to receive a DC input voltage, and to output a sum of the threshold voltage and the received DC input voltage; and
a device parameter extraction unit having a MOS transistor and configured to apply the output voltage of the threshold voltage extraction unit to a gate of the MOS transistor of the device parameter extraction unit such that a drain current of the MOS transistor of the device parameter extraction unit is proportional to the device parameter.

10. A method, comprising:
adaptive biasing at least one MOS transistor in an integrated circuit in a saturation region, the adaptive biasing comprising the steps of:
extracting a device parameter of the integrated circuit; and
generating a bias current which is inversely proportional to the extracted device parameter.

11. The method of claim 10, further comprising:
multiplying the generated bias current by a value to obtain an adaptive biasing current supplied to the at least one MOS transistor.

12. The method of claim 10 wherein the at least one MOS transistor comprises a plurality of MOS transistors, the method further comprising:
multiplying the generated bias current by a set of values to generate a plurality of adaptive biasing currents; and
supplying the plurality of adaptive biasing currents to respective MOS transistors in the plurality of MOS transistors.

13. An integrated circuit, comprising:
a plurality of MOS transistors:
means for extracting a device parameter of the integrated circuit;
means for generating a bias current that is inversely proportional to the extracted device parameter; and
means for providing a plurality of adaptive bias currents to respective MOS transistors of the plurality of MOS transistors.

14. The integrated circuit of claim 13, wherein the means for extracting comprises:
a voltage extraction unit; and
a parameter extraction unit.

15. The integrated circuit of claim 14 wherein the means for generating a bias current comprises a calculator unit coupled to the parameter extraction unit.

16. The integrated circuit of claim 14 wherein the voltage extraction unit comprises a current mirror.
